(19) United States
(12) Patent Application Publication
(10) Pub. No.: US 2025/0001508 A1
(43) Pub. Date: Jan. 2, 2025

(54) machining device equipped with guiding means and method for producing an orifice with such a device

(71) Applicant: SAFRAN NACELLES, Gonfreville-L'Orcher (FR)

(72) Inventors: Pierre-Yves GINI, Moissy-Cramayel (FR); Marc VERSAEVEL, Moissy-Cramayel (FR); Denis RAMAGE, Moissy-Cramayel (FR)

(21) Appl. No.: 18/757,348

(22) Filed: Jun. 27, 2024

(30) Foreign Application Priority Data
Jun. 28, 2023 (FR) 2306807

(51) Int. Cl. B23B 47/28; B23B 35/00; B23B 39/04; B23B 39/10; B23Q 11/10

(52) U.S. Cl. CPC B23B 47/28; B23B 35/00; B23B 39/04; B23B 39/10; B23Q 11/10

(57) ABSTRACT

A machining device for producing at least one orifice in a workpiece made of composite material, the machining device including a tool holder and at least one drill bit mounted on the tool holder, the drill bit being configured to be driven in rotation about an axis of rotation. The machining device includes a cylindrical guide body coaxial with the axis of rotation, mounted on the tool holder, and surrounding the drill bit, the guide body being configured to bear on the workpiece during the production of the orifice and the drill bit projecting from the guide body.

### TECHNICAL FIELD OF THE INVENTION

The present invention relates to a machining device for producing at least one orifice in a workpiece, such as an aircraft turbomachine workpiece. The invention also concerns a method for producing an orifice in a workpiece using such a machining device.

### TECHNICAL BACKGROUND

The prior art comprises documents U.S. Pat. Nos. 2,339,324, 2,794,353 and 5,033,917.

Some turbomachines, in particular double-flow turbomachines with a longitudinal axis, are equipped with one or more acoustic panels allowing to reduce noise. These acoustic panels are sandwich structures consisting of an acoustic skin (usually a multi-perforated skin), a honeycomb core and a solid skin. The acoustic skin is generally in contact with the air flow passing through the turbomachine so as to attenuate the noise generated by the air flow. The presence of the acoustic orifices increases the roughness of the wall of the duct and the pressure drop in the duct.

Each orifice is drilled using a drill bit, for example. The drill bit generally has a diameter of between 1.4 and 2.6 mm. The drilling may be carried out manually, using a numerical control system or by a multispindle drilling robot.

The pressure drops induced by the presence of the acoustic orifices depends in particular on the diameter of the orifices and of the porosity (density of orifices) of the acoustic skin. All other things being equal, increasing the diameter of the orifices leads to an increase in pressure drop and porosity. However, the porosity of the acoustic skin is dictated by acoustic performance. Reducing the porosity of the acoustic skin may not really reduce the pressure drops.

On the other hand, the pressure drops may be limited by reducing the diameter of the orifices. The reduced diameter may be 0.3 mm, for example. This diameter is much smaller than that currently used for the acoustic panels mounted in the turbomachine or aircraft nacelles. A drill bit with such a small diameter may be very sensitive to the angle at which it strikes the acoustic panel, and may break at the slightest deviation due to its orientation or its slipping. A “rebound” effect that occurs after the drill bit has passed through the acoustic panel may also cause the drill bit to break. In particular, once the orifice has been drilled, the acoustic panel, stressed during the drilling phase, returns to its initial position, which may create a lateral force on the drill bit and cause the latter to break. Mechanical clamping elements installed around the perimeter of the acoustic panel may allow to minimize the bounce of the acoustic panel. In the case of a large workpiece, the disadvantage of the mechanical clamping elements is that they are not very effective when faced with the numerous areas to be drilled and their locations. The same type of disadvantage occurs with a vacuum clamping table. Another type of clamping is to apply an adhesive tape to the panel to be drilled. However, the adhesive tape tends to stick to the drill bit and cause it to break.

There is a need to resolve some or all of the above disadvantages.

### SUMMARY OF THE INVENTION

The aim of the present invention is to provide a simple, economical and robust solution that improves the performance of a machining device while allowing to reduce the pressure drops on a workpiece drilled with such a device.

This objective is achieved in accordance with the invention by means of a machining device for producing at least one orifice in a workpiece made of composite material, the machining device comprising a tool holder and at least one drill bit mounted on the tool holder, the drill bit being configured to be driven in rotation about an axis of rotation, the machining device comprising a cylindrical guide body coaxial with the axis of rotation, mounted on the tool holder, and surrounding the drill bit, the guide body being configured to bear on the workpiece during the production of the orifice and the drill bit projecting from the guide body.

Thus, this solution allows to achieve the above-mentioned objective. In particular, the guide body allows, on the one hand, to hold and guide the drill bit in position and, on the other hand, to limit or even cancel the rebound effect that occurs when the workpiece has been drilled. The guide body allows a force to be applied to the workpiece while making an orifice. This allows to drill small-diameter orifices to allow to reduce the pressure drops. This solution is also more economical, as there is less drill bit breakage, and it saves time by reducing maintenance. Added to this is the fact that the guide body is a simple and economical solution; it is easy to make and does not involve any substantial modifications to the tool holder or other members of the machining device.

The machining device also comprises one or more of the following characteristics, taken alone or in combination:
the guide body is shorter than the length of the drill bit.
the guide body is made of metallic material or a metallic alloy.
the tool holder has at least one circular cross-section and the guide body has an external diameter equal to or less than the external diameter of the tool holder.
the guide body comprises a guide portion for the drill bit and a dust suction portion which are arranged along the axis of rotation.
the guide portion has an internal diameter which is smaller than the internal diameter of the suction portion.
the guide body comprises a first suction portion and a second suction portion, the guide portion being located between the first suction portion and the second suction portion along the axis of rotation.
the guide body comprises a plurality of passages formed in a thickness of the guide portion and extending along the axis of rotation, each passage opening into at least one suction portion.
the guide body is movable in translation along its axis of revolution relative to the tool holder and to the drill bit, at least one portion of the guide body being guided in the tool holder, and in that it comprises an elastic return member which is configured so as to keep a second surface of the guide body in contact or under pressure with a leading surface of the workpiece.
the guide body extends between a first end and a second end along an axis of revolution, and in that an intermediate workpiece is arranged at one of the first end and the second end of the guide body, the intermediate workpiece being made of a material different from that of the guide body.
the intermediate workpiece is selected from the group comprising a damping element, a washer and a sealing member.
a guide ring is arranged at the level of the guide portion.
a lubrication system is arranged in the guide portion.
the machining device comprises a plurality of drill bits which are mounted on the tool holder and which are spaced apart from one another, a plurality of guide bodies being arranged so as to surround respectively a drill bit.
the machining device comprises a motor configured to drive one or more drill bits,
the first end of the guide body is attached to the receiving surface of the tool holder.
the guide body may slide relative to the drill bit and to the tool holder along the axis of rotation, the tool holder comprising a slot centered on the axis of rotation of the drill bit and opening onto the receiving surface of the tool holder, the slot receiving at least the first end of the guide body,
the toolholder has a generally cylindrical shape with an axis of revolution and comprises an external cylindrical surface which is connected to a receiving surface, the receiving surface being defined in a plane which is perpendicular to the axis of revolution of the tool holder and bounded by an annular shoulder centered on the axis of revolution, the drill bit projecting from the receiving surface and the tool holder moving in translation away from or towards the workpiece, the guide body is removably mounted on the tool holder,
the guide body extends at least in part from the receiving surface between a first end and a second end.

The invention also relates to a method for machining a workpiece made of composite material, comprising the following steps:
supplying a workpiece made of composite material,
supplying a machining device having any of the above characteristics, and
producing at least one orifice in the workpiece using at least one drill bit.

According to the method, the composite material comprises carbon fibers and an epoxy-based resin.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 illustrates an axial cross-section of an example of a machining device configured to produce a through orifice in a workpiece according to the invention;

FIG. 2 shows an axial cross-section of another embodiment of a machining device equipped with a movable guide member according to the invention;

FIG. 3 shows, in axial cross-section, another embodiment of a machining device equipped with several machining accessories according to the invention;

FIG. 4 is a cross-sectional view of a member of the guide device shown in FIG. 3;

FIG. 5 illustrates yet another embodiment of a machining device equipped with several machining accessories according to the invention;

FIG. 6 illustrates yet another embodiment of a machining device equipped with several machining accessories according to the invention;

FIG. 7 is an axial sectional view of another embodiment of a machining device equipped with several machining accessories according to the invention;

FIG. 8 is a cross-sectional view AA of a member of the machining device shown in FIG. 7; and,

FIG. 9 shows a flowchart of a method for machining a composite material workpiece.

### DETAILED DESCRIPTION OF THE INVENTION

In the following description, identical or substantially identical elements and/or elements with the same functions are represented by the same numerical references.

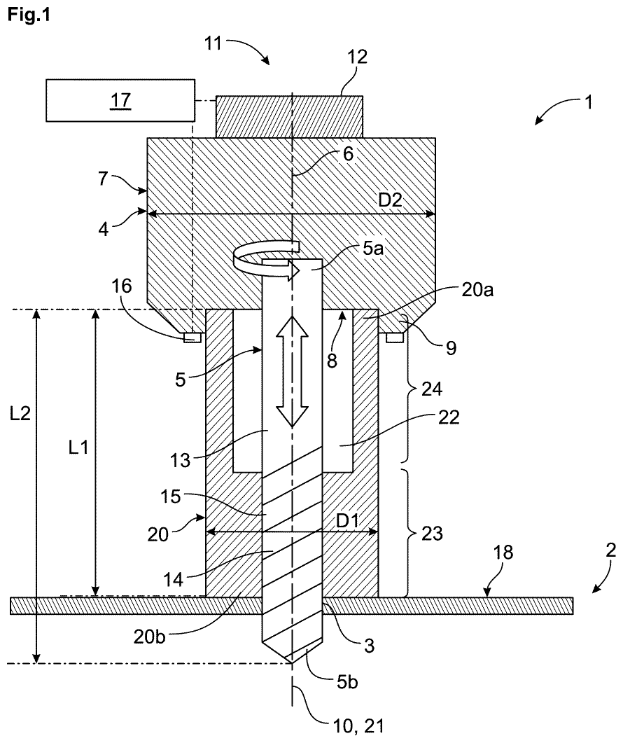

FIG. 1 shows partially a device 1 for machining a workpiece 2 made of composite material. The machining device 1 is configured to produce at least one orifice 3 in the composite material workpiece 2.

The composite material comprises reinforcing fibers densified in a matrix. The fibrous reinforcement is made by weaving, superimposing sheets with fibers oriented in different directions, or is made from several plies of fibers pre-impregnated with a resin. The reinforcing fibers may be carbon, glass, ceramic, Kevlar®, polyamide, etc. or a mixture of these fibers. Advantageously, but without limitation, the fibers are made of carbon.

The matrix is preferably an organic matrix and may be a thermoplastic resin or a thermosetting resin. The resin may advantageously be an epoxy-based resin. In this description, the terms “resin” and “matrix” are equivalent.

The composite material workpiece 2 may be a turbomachine workpiece, which is not shown. The turbomachine is configured to be mounted on an aircraft, such as an aeroplane. The turbomachine may be a turbojet engine such as a turbofan, a turboprop equipped with at least one unducted propeller (also referred to as open rotor) or a turboshaft engine.

An example of a composite material workpiece 2 for a turbomachine is an acoustic panel centered around a longitudinal axis of the turbomachine. The acoustic panel may be equipped to a fan casing or a nacelle of a turbomachine.

Of course, the composite material workpiece 2 with through orifices obtained by drilling may be another turbomachine workpiece or may be applicable to other types of field, for example automotive.

With reference to FIG. 1, the machining device 1 comprises a tool holder 4 and a machining accessory 5. The machining accessory is configured to drill through a wall and is in this case a drill bit. The tool holder 4 is configured to be mounted on an arm of a robot, in particular a 5-axis type robot (not shown).

The tool holder 4 has a generally cylindrical shape with an axis of revolution 6. The tool holder 4 comprises an external cylindrical surface 7 which is connected to a receiving surface 8. The latter is defined in a plane perpendicular to the axis of revolution 6 of the tool holder 4. The receiving surface 8 is advantageously delimited by an annular shoulder 9 centered on the axis of revolution 6. Advantageously, but without limitation, the tool holder 4 moves in translation away from or towards the workpiece 2 to be drilled. Advantageously, the tool holder 4 may be equipped with a mechanical slide system to allow this movement.

The drill bit 5 extends along an axis of rotation 10. The drill bit 5 is mounted in rotation on the tool holder 4 along the axis of rotation 10. In this case, the tool holder 4 is attached relative to the drill bit 5.

To this end, the machining device 1 comprises a system 11 for driving the drill bit 5 in rotation. The drive system 11 comprises a motor 12 which is shown schematically in FIG. 1. The drive system 11 comprises a drive shaft (not shown) which is coupled on the one hand to the motor 12 and on the other hand to the drill bit 5. The tool holder 4 allows to keep the drill bit 5 coaxial with the axis of rotation of the motor 12.

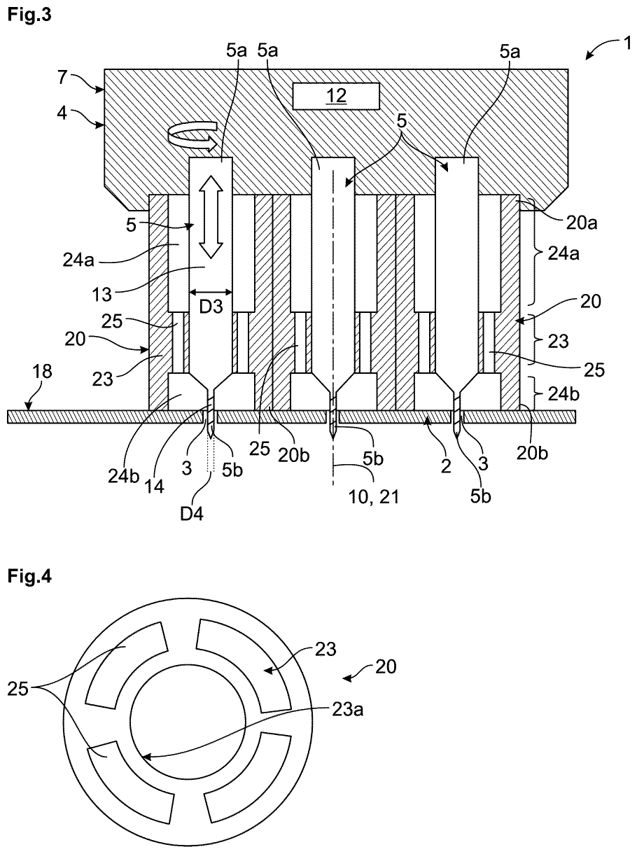

Alternatively, the drive system 11 with the motor 12 may be integrated into the tool holder 4 as shown in FIG. 3. Alternatively, the motor 12 is arranged in the robotic arm.

Advantageously, the tool holder 4 is equipped with detection means 16 which are configured to detect and transmit information relating to the position of the tool holder 4 or of the drill bit 5. The detection means 16 may be a presence sensor, a position sensor, a contact sensor or a combination of these sensors. The detection means 16 are connected to an electronic control unit 17 shown schematically. The latter is equipped with calculation, memory and information processing means allowing the machining device 1 to act and/or react according to the information received from the detection means 16. The electronic control unit 17 may be mounted in the tool holder 4 or in the robotic arm. The motor 12 may be connected to the electronic control unit 17.

The drill bit 5 extends in particular between a proximal end 5a and a distal end 5b. The drill bit 5 has a cross-section transverse to the axis of rotation 10 which is circular or generally circular.

Generally speaking, the drill bit 5 comprises a first part 13 which is smooth and a second part 14 which comprises cutting edges or lips 15. In FIG. 1, the cutting lips 15 are arranged helically around the axis of rotation 10. However, these could be straight or in any other shape or arrangement. The cutting lips 15 extend from the first portion 13 to the distal end 5b which is free. The first part 13 and the second part 14 of the drill bit 5 have the same diameter. Of course, the diameters of the first and second parts 13, 14 could be different. The proximal end 5a of the drill bit 5 is coupled to the motor 12 via the drive shaft of the motor 12. The drill bit 5 is typically attached to the drive shaft by a collet (not shown) and a nut (not shown). Other coupling means may be envisaged for attaching and rotating the drill bit 5.

Advantageously, the drill bit 5 projects from the receiving surface 8. The drive shaft and the drill bit 5 are preferably coaxial. We understand that there is a single motor 12 and a single drill bit 5 in this embodiment.

The distal end 5b is configured to come into contact with a leading surface 18 of the workpiece 2 and to pass through the workpiece 2 while the orifice 3 is being drilled. Advantageously, but without limitation, the orifice 3 passes through the thickness of the wall of the workpiece 2 on both sides.

In this example, the drill bit 5 is made from a metallic material or metallic alloy. An example of a metallic material is steel. Alternatively, the drill bit 5 is made from a ceramic material. The ceramic may be alumina (Al2O3) or zirconia (Zr02) or a mixture of at least one of these two compounds.

As shown in FIG. 1, the machining device 1 comprises a guide body 20. The guide body 20 is configured to bear on the workpiece 2 during machining, and in particular during the production of the orifice 3. Advantageously, the guide body 20 is cylindrical and is mounted on the tool holder 4. The guide body 20 has an axis of revolution 21 which is coaxial with the axis of rotation 10 of the drill bit 5.

In particular, the guide body 20 advantageously extends between a first end 20a and a second end 20b along the axis of revolution 21. The guide body 20 has a constant circular cross-section along its axis of revolution 21. Of course, the guide body 20 may have a different cross-section. Advantageously, as may be seen in FIG. 1, the guide body extends at least in part from the receiving surface 8.

In the present example of embodiment, the guide body 20 has an external diameter D1 equal to or less than the external dimensions (here diameter D2) of the tool holder 4. This means that the dimensions of the machining device 1 are not affected and the latter is not bulky.

Advantageously, the guide body 20 is hollow and has a longitudinal cavity 22 which opens out at the first end 20a and at the second end 20b. The guide body 20 is arranged so as to surround the drill bit 5 preferably over a major part of the length of the drill bit. In other words, the drill bit 5 is engaged inside the longitudinal cavity 22 of the guide body 20 and passes through it on either side along the axis of revolution 21. Advantageously, but without limitation, the longitudinal cavity 22 has a circular cross-section. In this example of embodiment, the longitudinal cavity 22 has different diameters.

Still referring to FIG. 1, the first end 20a of the guide body 20 is attached to the receiving surface 8 of the tool holder 4. The first end 20a surrounds the drill bit. This attachment may be achieved by means of a magnetic system. To this end, the first end 20a and the receiving surface 8 are equipped with magnets which face each other and are in contact to ensure the holding. Alternatively, the attachment may be screwed in place. For example, the first end 20a comprises a thread on its external surface cooperating with a tapped surface carried by the shoulder 9 of the tool holder 4. In another example, the screwing is achieved using “quarter-turn” type elements. The attachment may also be achieved, advantageously but not exclusively, by clipping elements. In this case, the first end 20a of the guide body 20 and the tool holder 4 comprise complementary members to achieve this type of attachment.

The second end 20b has a flat surface in complementary contact with the leading surface 18 of the workpiece to be drilled. Alternatively, the second end 20b has a curved surface complementary to the leading surface 18 of the workpiece 2.

The guide body 20 has a length L1 that is less than the effective length L2 of the drill bit 5. The length L1 of the guide body 20 is measured between the first end 20a and the second end 20b. The effective length L2 of the drill bit 5 is measured between the receiving surface 8 and the distal end of the drill bit 5.

Advantageously, the guide body 20 is removably mounted. This allows the guide body 20 to be replaced if damaged, or the drill bit 5 to be replaced with another drill bit of a different diameter, for example.

The guide body 20 is made of a “hard” or “soft” material. The material of the guide body 20 is hard or soft compared to the material of the drill bit. The material of drill bit 5 in the present invention is considered canonical. In particular, the guide body 20 is made of a metallic, ceramic and/or carbide material. An example of metallic material is steel, aluminum, bronze and brass. The hard materials are steel and carbide, while soft materials are aluminum, bronze and brass.

Referring to FIG. 1, the guide body 20 comprises a guide portion 23 for the drill bit 5. As its name suggests, this guide portion 23 is used to guide the drill bit 5 and to hold the drill bit 5 along its axis of rotation 10 as it rotates, particularly when drilling the workpiece 2. The guide portion 23 is located towards the second end 20b of the guide body 20.

The guide body 20 also comprises a suction portion 24 which allows chips or dust from the material of the workpiece 2 to be removed during machining, for example. This also prevents clogging of the drill bit 5 and an increase in the temperature of the drill material.

The suction portion 24 is located towards the first end 20a of the guide body 20. The suction portion 24 and the guide portion 23 are arranged along the axis of revolution 21 of the guide body 20. In particular, the suction portion 24 opens into the first end 20a, while the guide portion 23 opens into the second end 20b. In other words, the suction portion 24 surrounds a portion of the drill bit. Advantageously, the suction portion opens onto the receiving surface 8.

Advantageously, but without limitation, the guide portion 23 has an internal diameter which is smaller than the internal diameter of the suction portion 24. The internal diameter of the guide portion 23 allows the drill bit 5 to be guided more effectively, while the internal diameter of the suction portion 24 allows chips or dust to be removed efficiently from the leading surface 18 of the workpiece 2.

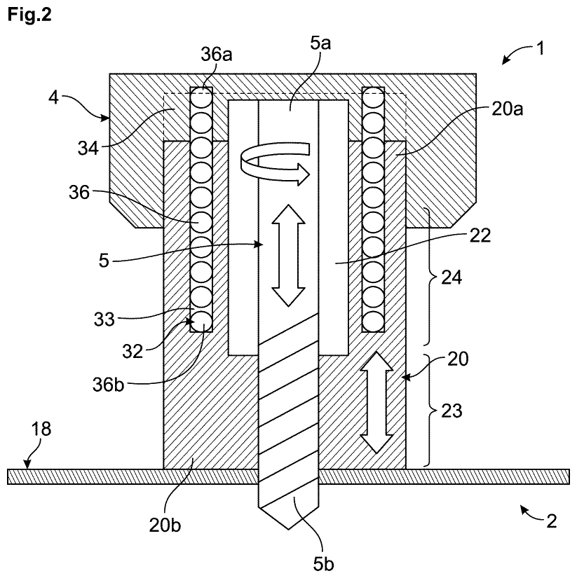

FIG. 2 illustrates a further embodiment of the guide device 1. The guide body extends at least in part from the receiving surface 8. This embodiment differs from FIG. 1 in that the guide body 20 is movable relative to the drill bit 5 and also relative to the tool holder 4. In this example, the guide body 20 slides along its axis of revolution 21. At least a portion of the guide body 20 is guided in the tool holder 4. To this end, the tool holder 4 comprises a slot 34 centered on the axis of rotation 10 of the drill bit 5 and which opens onto the receiving surface 8 of the tool holder 4. The slot 34 is configured to receive at least the first end 20a of the guide body 20. In this way, the guide body 20 moves inside the tool holder 4 as the drill bit 5 passes through the workpiece 2 to be drilled. The guide body 20 is always in contact with the leading surface 18 of the workpiece 2.

In addition, a resilient return member 32 is configured so as to keep the second end 20b of the guide body 20 in contact or under pressure with the leading surface 18 of the workpiece 2. The elastic return member 32 is preferably arranged between the guide body 20 and the tool holder 4. Advantageously, but without limitation, the elastic return member 32 is a compression spring 36. To this end, the guide body 20 comprises at least one groove 33 wherein the compression spring 36 is housed. In the present embodiment, the groove 33 is annular and centered on the axis of revolution 21 of the guide body. A single compression spring 36, centered on the axis of revolution 21, is housed in the groove 33. The compression spring 36 extends between a first end 36a and a second end 36b. The first end 36a is in contact with the bottom of the slot 34 provided in the tool holder 4 and the second end 36b is in contact with the bottom of the groove 33 made in the guide body 20. The leading surface 18 is flat but could have one or more curvatures as explained above.

FIG. 3 illustrates a further embodiment of the guide device 1. This embodiment differs from that of FIG. 1 in that the guide body 20 comprises two suction portions 24, referred to as first suction portion 24a and the second suction portion 24b. The guide portion 23 is located between the first suction portion 24a and the second suction portion 24b along the axis of revolution 21 of the guide body 20.

With reference to FIGS. 3 and 4, the guide body 20 comprises one or a plurality of passages 25 which are formed in a thickness of the guide portion 23. The passages allow to prevent dust and residues from passing through the guide portion and fouling it. Each passage 25 extends along the axis of revolution 21 (i.e., along the axis of rotation in the installation situation). The passages 25 are evenly distributed around the axis of revolution 21. Each passage 25 opens into both the first suction portion 24a and the second suction portion 24b. In the example shown, there are four passages 25. However, the number of passages 25 may be between 2 and 8. We may also see that each passage 25 also has a curvature around the axis of revolution 21.

The passages 25 could also be formed in the guide portion of the guide body 20, which comprises a single suction portion.

This embodiment also differs from the previous one in that the guide device 1 comprises several drill bits 5. In this example, the drill bits 5 are spaced apart. The proximal end 5a of each drill bit 5 is received in a housing in the tool holder 4. Each drill bit 5 is encased or surrounded by a guide body 20. The first end 20a of each guide body 20 is secured to the tool holder 4 and the second end 20b rests against the workpiece 2. In this way, a pressure is applied to the workpiece 2 so as to prevent it bouncing back. The smaller external diameter D1 of each guide body 20 compared to the external diameter D2 of the tool holder 4 allows several guide bodies 20 to be arranged side by side.

Here, each drill bit 5 has different diameters. In particular, each drill bit 5 comprises at its proximal end 5a a first diameter D3 which is greater than a second diameter D4 of the drill bit 5 at its distal end 5b. The first diameter D3 extends over the entire height of the first part 13, which is smooth and serves to guide the drill bit 5. The second diameter D4 is applied to the second cutting part 14. As the diameter of the drill bit 5 at its proximal end 5a is larger, the rigidity of each drill bit 5 remains greater. Of course, at least one of the drill bits 5 could have a single diameter along its entire length.

An advantageous but non-limiting characteristic of this embodiment is that at least one of the drill bits 5 slides along the axis of rotation 10. Advantageously, each drill bit 5 slides along the axis of rotation 10 independently of the other drill bits 5. This configuration allows the drill bits 5 to adapt to the leading surface 18, which may be convex or concave or have different curvatures.

Advantageously, but without limitation, the system 11 for driving the drill bits 5 comprises at least one motor 12. In this case, it is a single motor 12. Each drill bit 5 may be coupled directly to the drive shaft via the collet/nut system. Alternatively, the collet/nut system may be provided at the output of a gearbox (not shown). The gearbox would comprise an input connected to the single motor and several outputs rotated by gear sets. Alternatively, the drive system comprises several motors 12, each of which drives a drill bit 5.

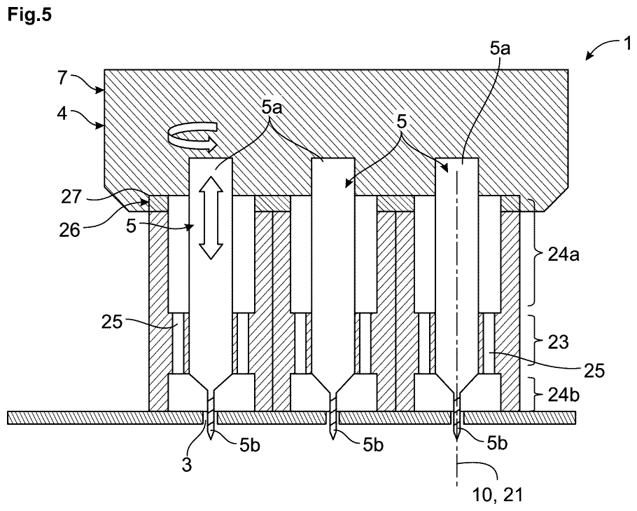

FIG. 5 illustrates a further embodiment of the guide device 1. This guide device 1 comprises several drill bits 5 and several guide bodies 20. Each guide body 20 comprises two suction portions 24a, 24b and a guide portion 23 equipped with passages 25.

This embodiment differs from the embodiment shown in FIG. 3 in that it comprises an intermediate workpiece 26 which is arranged at one of the first end 20a and second end 20b of the guide body 20. The intermediate workpiece 26 is an insert. The intermediate workpiece 26 is made of a different material to the guide body 20. This is advantageously attached to one of the ends 20a, 20b so as to make it easier to fit. The attachment is achieved, for example, by gluing, welding, shrinking or other suitable means at one of the ends.

In this example of embodiment, the intermediate workpiece 26 comprises a damping element 27 which is arranged between the receiving surface 8 of the tool holder 4 and the first end 20a of each guide body 20. The damping element 27 may be made of an elastomer. Such a material has a high capacity for deformation, compression and/or damping. In this way, when the tool holder 4 is brought close to the workpiece 2 and the guide body 20 is in contact with the leading surface 18 of the workpiece 2, each damping element 27 compresses. The damping element 27 allows to limit the impact of the guide body 20 being abutted or pressed against the workpiece 2.

Advantageously, but without limitation, the damping element 27 has an annular shape and is arranged over the entire surface of the first end 20a. This makes it easier to fit the damping element 27.

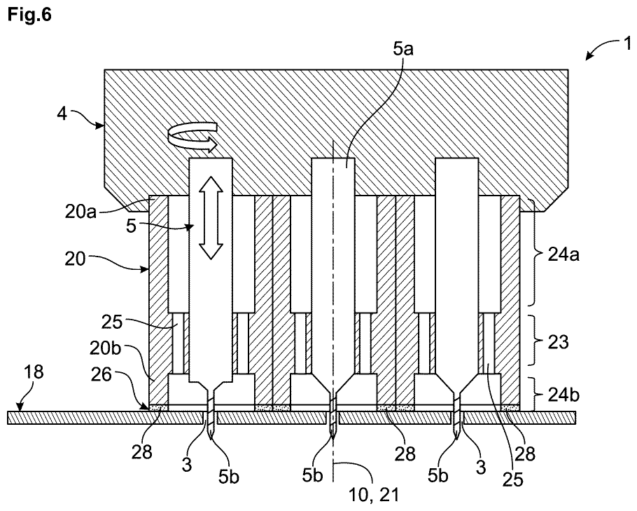

FIG. 6 shows a further embodiment. This machining device 1 comprises several drill bits 5 and several guide bodies 20. Each guide body 20 comprises two suction portions 24a, 24b and a guide portion 23 equipped with passages 25. This embodiment differs from the embodiment of FIG. 5 in that the intermediate workpiece 26 comprises a washer 28. The latter is attached to the second end 20b of each guide body 20. In other words, the washer 28 is located between the second end 20b and the leading surface 18 of the workpiece 2 when the orifice 3 is made in the workpiece. Advantageously, the washer 28 is made of an elastic, flexible material. An example of an elastic material is a thermoplastic, rubber or elastomer. This washer 28 acts as an “absorbing buffer”. The washer 28 also allows to help to reduce or eliminate the rebound effect. Advantageously, but not restrictively, the washer 28 is annular and is centered on the axis of rotation 10. Alternatively, the washer 28 could be arranged at the first end 20a.

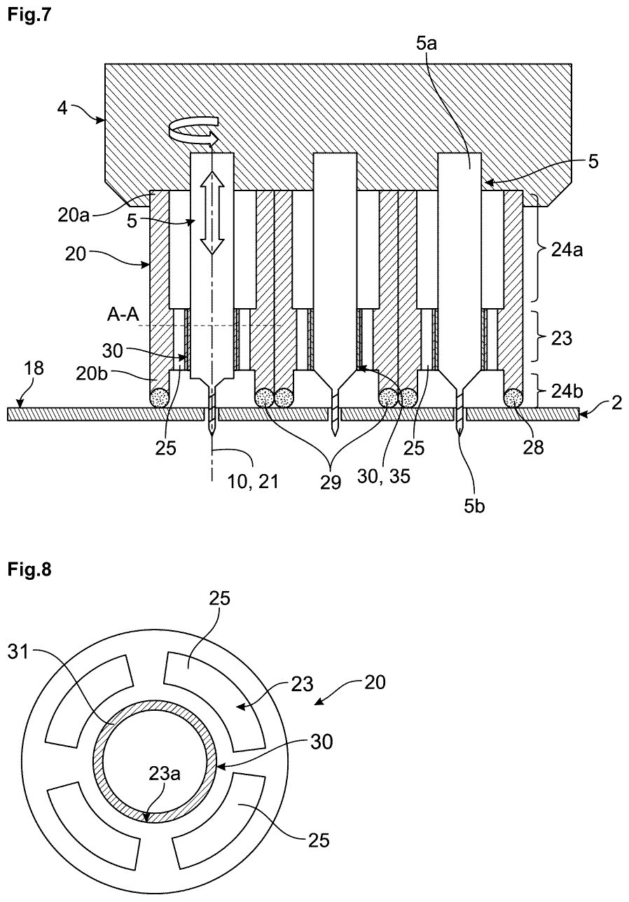

FIG. 7 illustrates yet another embodiment of a machining device 1. This machining device 1 comprises several drill bits 5 and several guide bodies 20 each surrounding a drill bit 5. The drill bits 5 are mounted or coupled to the tool holder 4. Each guide body 20 comprises two suction portions 24a, 24b and a guide portion 23 equipped with passages 25. This embodiment differs from the embodiments shown in FIGS. 5 and 6 in that the intermediate workpiece 26 comprises a sealing member 29. The latter is configured to be arranged between the workpiece 2 and the second end 20b of each guide body 20. The sealing member 29 provides a support area capable of absorbing incidence faults (normality faults) between the leading surface 18 of the workpiece 2 and the guide body 20. In addition, the sealing member 29 allows to dampen the tool holder 4 equipped with the drill bits 5 and reduces the slipping of the assembly (tool holder and drill bits) when the machining device 1 is brought into contact with the workpiece to be drilled.

Advantageously, the sealing member 29 is an annular seal or an O-ring centered on the axis of rotation 10. The sealing member 29 may be made of a polymer, rubber or elastomer, for example. This sealing member may withstand pressure and compression. In addition, such a sealing member 29 may be easily replaced during maintenance of the machining device 1.

Of course, the machining device 1 comprising a single drill bit 5 and/or a guide body 20 with a single suction portion 24 may be equipped with an intermediate workpiece 26 as described in the various embodiments above.

With reference to FIGS. 7 and 8, the machining device 1 also comprises guide elements 30 for the drill bit 5. These guide elements 30 are configured so as to guide the drill bit 5 during its rotation and to limit the friction between the guide body 20 and the drill bit 5. Advantageously, but without limitation, the guide elements 30 are made from a different material to that of the guide body 20. In this example of embodiment, the guide elements 30 comprise a ring 31. The latter is centered on the axis of rotation 10 and is arranged at the level of the guide portion 23 of each guide body. More specifically, the ring 31 is attached to the radially internal surface 23a of the guide portion 23. Advantageously, the attachment is achieved by means of welding, hooping, gluing, crimping or any suitable means. The ring 31 is made of a metallic material such as brass or bronze. Alternatively, the ring 31 could be made of a polymer material such as polytetrafluoroethylene (PTFE). The drill bit 5 slides and rotates inside the ring 31. As the drill bit moves, it rubs against the ring 31.

Alternatively, the guide elements 30 comprise balls (for example three in number) (not shown) each mounted on a spring attached to the radially internal surface 23 of the guide portion. The balls are positioned at 120° to each other around the axis of revolution 21.

In one variant embodiment, which is shown on one of the drill bits 5 in FIG. 7, the machining device 1 comprises a lubrication system 35 configured to reduce friction and heating of the drill bit 5 which may be in contact with the guide body 20. The lubrication system 35 is arranged in the guide portion 23 of a guide body 20. Specifically, the lubrication system 35 is located between the drill bit 5 and the radially internal surface 23a of the guide portion 23. Only one guide body 20 equipped with the lubrication system 35 is shown in FIG. 7, but all the guide bodies 20 may be equipped. Advantageously, the lubrication system 35 comprises holes (not shown) which open onto the radially internal surface 23a. The holes are connected to a lubricant supply source in the lubrication system.

In another variant of embodiment shown on one of the drill bits 5 in FIG. 7, the machining device 1 comprises the lubrication system 35 and the guide elements 30. In this case, the lubrication system 35 is mounted radially inside the guide elements 30.

Of course, the machining device 1 comprising a single drill bit and/or a guide body 20 with a single suction portion 24 may be equipped with a lubrication system 35 or guide elements 30 as described in the various embodiments above.

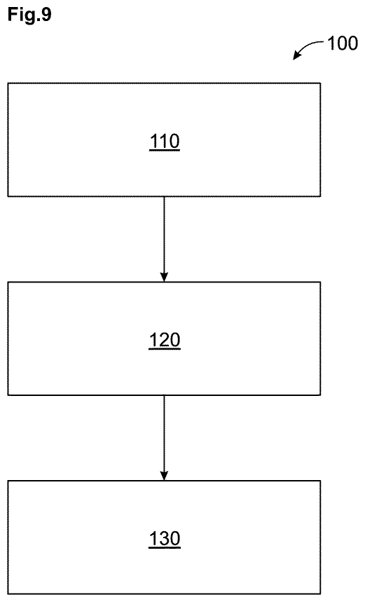

We will now describe a method 100 for machining a workpiece 2 made of composite material. The method is implemented using the machining device 1 and is shown in FIG. 9.

The method 100 comprises a step 110 of supplying a workpiece 2 made of composite material to be drilled. This workpiece may be, for example, a monolithic skin or a sandwich structure (e.g., formed by two skins glued to a honeycomb).

The method comprises a step 120 of supplying the machining device 1. The drill bit or drill bits 5 are already mounted on the tool holder 4.

The supply step 120 comprises a sub-step 121 of fitting the guide body 20 onto the tool holder 4. To this end, the drill bit or bits 5 already mounted on the tool holder 4 are engaged inside the guide body 20. Once the guide body 20 has been installed, the drill bit 5 projects from it, as the length of the guide body 20 is less than that of the drill bit 5. The difference in length means that the drill bit 5 may drill through workpiece 2 without obstruction. In other words, the drill bit 5 projects from the guide body 20 before and after machining the workpiece 2.

The supply step 120 may comprise a sub-step 122 of mounting the tool holder 4 on the portable machine or the robotic arm.

The method 100 also comprises a step 130 of making at least one orifice in the workpiece using the drill bit or bits 5. During this step, the tool holder 4 is moved towards the workpiece 2 so that the distal end 5b of the drill bit 5 is in contact with the leading surface 18 of the workpiece. The drill bit 5 is driven in rotation about its axis of rotation 10 when the portable machine or robotic arm is switched on.

In the case of a robot equipped with the tool holder 4, when at least one sensor of the detection means 16 determines that the tool holder 4 is close to the workpiece 2, a command to slow down the approach of the tool holder 4 is sent to the motor 12.

The drill bit 5 begins to drill the workpiece until the first end 20b of the guide body 20 is in abutment against the leading surface 18 of the workpiece 2.

If the intermediate workpiece 26 is placed on the second end 20b of the guide body 20, the intermediate workpiece 26 is brought into contact with the leading surface 18 of the workpiece 2 and compresses to slow the approach of the tool holder 4.

In the case where the intermediate workpiece 26 is placed on the first end 20a of the guide body 20, the second end 20b of the guide body 20 is brought into contact with the leading surface 17 and then the intermediate workpiece 26 compresses to slow down the approach of the tool holder.

The guide body 20 surrounding the drill bit 5 and abutting against the workpiece 2 during machining allows to reduce the breakage rate of the drill bit or bits 5 and increases the productivity for orifices with very small diameters, i.e., diameters of less than 1 mm, preferably between 0.1 mm and 0.5 mm. In this way, the guide body 20 prevents the drill bit 5 from slipping when it starts to drill into the workpiece 2 and pressurizes the workpiece 2 to avoid the rebound effect when the drill bit 5 leaves the material after drilling. The orifices with a diameter of less than 1 mm are used to reduce pressure drops associated, for example, with acoustic treatment of the workpiece.

1. A machining device for producing at least one orifice in a workpiece made of composite material, the machining device comprising a tool holder and at least one drill bit mounted on the tool holder, the drill bit being configured to be driven in rotation about an axis of rotation, characterized in that the machining device comprises a cylindrical guide body coaxial with the axis of rotation, mounted on the tool holder, and surrounding the drill bit, the guide body being configured to bear on the workpiece during the production of the orifice and the drill bit projecting from the guide body.

2. The machining device according to claim 1, wherein the guide body has a length (L1) less than a length (L2) of the drill bit.

3. The machining device according to claim 1, wherein the guide body is made of a metallic material or a metallic alloy.

4. The machining device according to claim 1, wherein the tool holder has at least one circular cross-section and the guide body has an external diameter (D1) equal to or less than the external diameter (D2) of the tool holder.

5. The machining device according to claim 1, wherein the guide body comprises a guide portion for the drill bit and a dust suction portion which are arranged along the axis of rotation.

6. The machining device according to claim 5, wherein the guide portion has an internal diameter which is smaller than the internal diameter of the suction portion.

7. The machining device according to claim 5, wherein the guide body comprises a first suction portion and a second suction portion, the guide portion being located between the first suction portion and the second suction portion along the axis of rotation.

8. The machining device according to claim 5, wherein the guide body comprises a plurality of passages formed in a thickness of the guide portion and extending along the axis of rotation, each passage opening into at least one suction portion.

9. The machining device according to claim 1, wherein the guide body is movable in translation along its axis of revolution relative to the tool holder and to the drill bit at least one portion of the guide body being guided in the tool holder and in that it comprises an elastic return member which is configured so as to keep a second surface of the guide body in contact or under pressure with a leading surface of the workpiece.

10. The machining device according to claim 1, wherein the guide body extends between a first end and a second end along an axis of revolution and in that an intermediate workpiece is arranged at one of the first end and second end of the guide body, the intermediate workpiece being made of a material different from that of the guide body.

11. The machining device according to claim 5, wherein a guide ring is arranged at the level of the guide portion.

12. The machining device according to claim 5, wherein a lubrication system is arranged in the guide portion.

13. The machining device according to claim 12, wherein it comprises a plurality of drill bits which are mounted on the tool holder and which are spaced apart from one another, a plurality of guide bodies being arranged so as to surround respectively a drill bit.

14. The machining device according to claim 1, wherein it comprises a motor configured to drive one or more drill bits.

15. A method for machining a workpiece made of composite material, comprising the following steps:
supplying a workpiece made of composite material,
supplying a machining device according to claim 1, and
producing at least one orifice in the workpiece using the drill bit.
